(19) United States
(12) Patent Application Publication
(10) Pub. No.: US 2006/0166669 A1
(43) Pub. Date: Jul. 27, 2006

(54) Brokering services between wireless device users and operators

(76) Inventor: Holger Claussen, Swindon (GB)

Correspondence Address: WILLIAMS, MORGAN & AMERSON, 10333 RICHMOND, SUITE 1100, HOUSTON, TX, 77042, US

(21) Appl. No.: 11/044,250

(22) Filed: Jan. 27, 2005

(51) Int. Cl. H04Q 7/20

(52) U.S. Cl. 455/435.3; 455/453

(57) ABSTRACT

The present invention provides a method and an apparatus for brokering a service contract between a user of a mobile communication device and an operator to provide a service over a network. Specifically, the method comprises receiving information on traffic load on a network and a negotiated price of a type of a wireless service based on a location of a user in the network. The method further comprises using information on the negotiated price to determine price data and demand data for the type of wireless service based on the location of the user and/or the traffic load on the network. In this way, the method may estimate cost of providing the wireless service to the user by a first operator based on the price data and demand data. For example, a telecommunication system includes a broker for exchanging data over a network between a plurality of mobile communication devices each including a user negotiating agent and a multiplicity of operators each including an operator negotiating agent to negotiate a service cost according to one illustrative embodiment. In response to a request for a wireless service, a service brokering agent may predict a price of the request to the user based on a price data map and a demand data map and provide pricing statistics associated with the request to an operator, resulting in substantial price savings to the user and additional revenue to the operator.

### BACKGROUND OF THE INVENTION

1. Field of the Invention

This invention relates generally to telecommunications, and more particularly, to wireless communications.

2. Description of the Related Art

More and more, wired and wireless device users and mobile service subscribers demand a wide array of services including voice and data services at affordable prices. This convergence of voice and data services has attracted many competitors, wanting to serve enterprise customers. Deregulation has also resulted in more participants that provide voice transport services. As a result, network operators or service providers face a communications environment in which delivering services what the customers desire while staying profitable has become difficult. Rolling out new services and scaling up the same rapidly in a particular communications environment is especially important for network operators or service providers. Thus, to retain profitability while lowering service costs to customers, carriers of such services constantly manage and evolve their networks to deliver customizable services to a wide range of users and enterprises with unique needs.

In an agent-based network architecture, a price for a requested user service is negotiated between a user and an available network operator or service provider using a broker. A broker generally refers to a software entity that may exchange data between mobile terminals or wireless communication devices and network operators or service providers, which use auctioning mechanisms to negotiate service contracts or agreements between users and network operators or service providers. Network operators are owners of wireless access networks, including a global system for mobile communications (GSM), a universal mobile telecommunications system (UMTS), a wide local area network (WLAN), and the like, which provide transport for data, voice, video or other services. Usually, the networks of different operators overlap a particular region or area, such that a user may connect to more than one network operator or service provider at each location.

Generally, the service price depends upon several parameters including a kind or type of a service, a channel condition to the user, (for example, depending upon the position of the user), a current interference level and a current network load. However, these parameters do vary significantly, depending upon many factors, such as the location and time of the day. Specifically, the channel conditions may vary by more than 100 dB (>factor of 10¹⁰) based on the user location. Moreover, the mobility of the user also results in changes of a downlink interference level. Depending upon the time of the day and the location, a network may be either congested or lightly loaded.

However, a user is unable to estimate a service cost depending on the location, the time of the day, or the current network traffic load. That is, a variation in cost may not be expected for a wireless service offered to a user by a network operator or a service provider. Therefore, a user may not effectively influence the price of the wireless service. In addition, the network operators or service providers may not be able to obtain location-dependent price statistics of various services for optimizing their networks due to lack of availability of pricing information of any competitors and/or do not offer coverage in all areas (such as WLAN operators). Because network operators or service providers cannot successfully optimize existing networks by reusing any embedded infrastructure (i.e., reconfigure or re-deploy base stations to more effective positions) and selectively adding systems when and where they're needed to offer new services, this approach fails to generate profitable revenue streams or reduce capital and/or operational expenses while simplifying network operations.

The present invention is directed to overcoming, or at least reducing, the effects of, one or more of the problems set forth above.

### SUMMARY OF THE INVENTION

In one embodiment of the present invention, a method is provided for brokering a service contract between a user of a mobile communication device and an operator to provide a service over a network. Specifically, the method comprises receiving information on traffic load on a network and a negotiated price of a type of a wireless service based on a location of a user in the network. The method further comprises using information on the negotiated price to determine price data and demand data for the type of wireless service based on the location of the user and/or the traffic load on the network. In this way, the method may estimate cost of providing the wireless service to the user by a first operator based on the price data and demand data.

In another embodiment, a mobile communication device associated with a network comprises an agent capable of communicating with a broker adapted to negotiate a price of a wireless service from a first operator within a service coverage area for a user, wherein the broker may use the method set forth above.

In yet another embodiment, an operator may associate with a network to provide a wireless service to a mobile communication device. The operator may comprise an agent capable of communicating with a broker adapted to negotiate a price of the wireless service for a user within a service coverage area, wherein the broker may use the method set forth above.

In still another embodiment, a telecommunication system comprises a broker including a controller that negotiates a price of a request within a service coverage area from a user for a wireless service between a first operator coupled to one or more mobile communication devices over a network and a memory coupled to the controller. The memory may store instructions to implement the method set forth above.

In a further embodiment, an apparatus for exchanging data with a mobile communication device and an operator over a network to negotiate a service contract between a user and a service provider, may comprise means for receiving information on traffic load on the network and a negotiated price of a type of a wireless service based on a location of the user in the network, means for using information on the negotiated price to determine price data and demand data for the type of the wireless service based on at least one of the location of the user and the traffic load on the network and means for estimating cost of providing the wireless service to the user by the operator based on the price and demand data.

In an exemplary embodiment, an article comprising a computer readable storage medium storing instructions that, when executed cause a system to receive information on traffic load on a network and a negotiated price of a type of a wireless service based on a location of a user in the network, use information on the negotiated price to determine price data and demand data for the type of wireless service based on at least one of the location of the user and the traffic load on the network, and estimate cost of providing the wireless service to the user by a first operator based on the price data and demand data.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a telecommunication system including a broker for exchanging data over a network between a plurality of mobile communication devices each including a user negotiating agent and a multiplicity of operators each including an operator negotiating agent to negotiate a service cost according to one illustrative embodiment of the present invention;

FIG. 2 illustrates the broker shown in FIG. 1 including a service brokering agent that uses information on negotiated prices to determine price data and demand data for a type of a wireless service based on a location of a user at a particular time and/or traffic load on the network for predicting a price of a request to the user and providing pricing statistics associated with the request to a first operator or a service provider in accordance with one illustrative embodiment of the present invention;

FIG. 3 illustrates an operator (e.g., an access point) including the operator negotiating agent shown in FIG. 1 for rendering a wireless service to the user in accordance with one illustrative embodiment of the present invention;

FIG. 4 illustrates a stylized representation of a flow chart implementing a method for estimating cost of rendering the wireless service to the user by the first operator based on the price data and the demand data consistent with one embodiment of the present invention; and

FIG. 5 illustrates a stylized representation of a flow chart implementing a method for brokering a service contract between the user and the first operator based on traffic load data of the network, price data and/or demand data consistent with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a broker may estimate cost of rendering a service, such as a wireless service to a user by an operator based on price data and demand data. To this end, the broker may comprise an agent that uses information on a negotiated price of a type of a wireless service based on a location of a user in a network at a particular time to determine the price data and demand data for that type of wireless service based on the location of the user at the particular time and/or traffic load on the network. The broker may generate a location and time and/or network traffic load based price and demand maps using the information from the negotiation outcomes. These price and demand maps may be used to extrapolate the service cost values from past experience to predict service prices for a desired location of a user at a particular time. The price and demand maps may be downloaded to a mobile communication device, as a user service. The downloaded price maps may allow the user to save money by moving to such regions with a relatively good channel conditions and/or a relatively less network traffic. Likewise, the generated price and demand maps may reveal expensive regions with relatively poor coverage or relatively high congestion area, providing additional revenue generation opportunities for the operators. In this manner, using the price and demand maps, an improved coverage and quality of service may be offered by the operators. The pricing information and user demand may be provided to the operators in a form of location and time dependent pricing and demand statistics to enable optimization of their networks. Accordingly, a network may be optimized for use by an operator that renders a wireless service within a service coverage area of a telecommunication system.

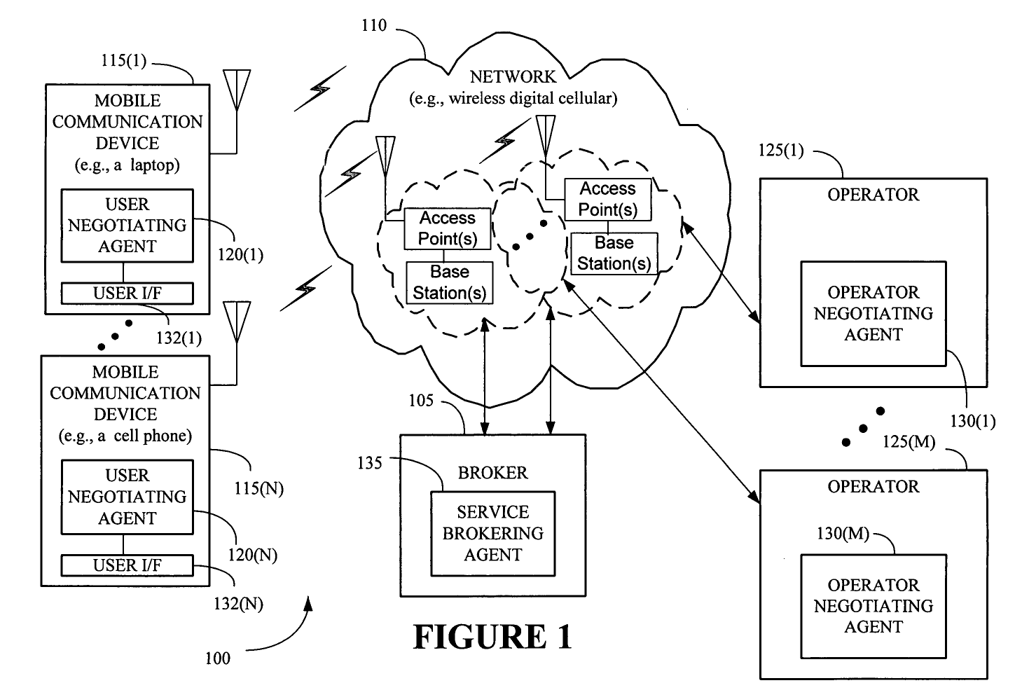

Referring to FIG. 1, a telecommunication system 100 includes a broker 105 for exchanging data over a network 110, such a wireless digital cellular network between a plurality of mobile communication devices 115(1-N) each including a respective one of user negotiating agents 120(1-N) and a multiplicity of operators 125(1-M) each including a corresponding one of operator negotiating agents 130(1-M) according to one illustrative embodiment of the present invention. In one embodiment, an agent may be a component of software, firmware and/or hardware which is capable accomplishing tasks on behalf of a user. For example, a software agent may comprise instructions in the form of program code to execute in a computing environment. The software agent may engage in database searches and transactions based upon a user profile that specifies one or more desires of an individual user. Although an agent-based network architecture is illustrated for the telecommunication system 100, a person of ordinary skill in the pertinent will recognize that other architectures may be readily deployed depending upon a particular application without departing from the sprit of the present invention.

Using the broker 105, one or more mobile communication devices 115(1-N) may communicate with one or more operators 125(1-M) to negotiate cost or price of a service to a user by a specific operator based on a location of the user at a particular time and/or traffic load on the network 110 of the telecommunication system 100. For example, the broker 105 may predict a price of a request of a desired service, such as a call, to the user and/or provide pricing statistics associated with that request to network operators or service providers being owners of the operators 125(1-M).

Examples of the telecommunication system 100 of FIG. 1 include a Universal Mobile Telecommunication System (UMTS), although it should be understood that the present invention may be applicable to other systems that support data and/or voice communication. That is, it should be understood, however, that the configuration of the telecommunication system 100 of FIG. 1 is exemplary in nature, and that fewer or additional components may be employed in other embodiments of the telecommunication system 100 without departing from the spirit and scope of the instant invention. Likewise, the mobile communication device 115 may take the form of any of a variety of devices, including cellular phones, personal digital assistants (PDAs), laptop computers, digital pagers, wireless cards, and any other device capable of accessing the network 110, such as the Internet, and/or a public telephone system (PSTN).

In one embodiment, the mobile communication device 115 may be defined at least in part by a UMTS protocol. In one embodiment, the operator 125 may be defined at least in part by a UMTS protocol. The wireless communications between the mobile communication devices 115(1-N) and the operators 125(1-M) may be established according to any one or more of network and/or communication protocols including, but not limited to, a UMTS protocol, a Global System for Mobile communications (GSM) protocol, a Code Division Multiple Access (CDMA) protocol, and the like. Use of a particular protocol in the telecommunication system 100 to communicate over a wireless communication medium is a matter of design choice and not necessarily material to the present invention. Thus, only relevant aspects of the telecommunication system 100 that are material to the instant invention are described below.

According to one embodiment, the network 110 may include one or more networks for each network provider providing the wireless service where an operator's network may include a plurality of base stations coupled to a plurality of access points distributed within an area, such as service coverage area, to be serviced by the operators 125(1) across an air interface. To provide the wireless service to a user, the base stations may transmit and receive messages from the communication devices 115(1-N), e.g., laptop computers or cell phones, in a cell that may be divided into multiple sectors.

Besides the user negotiating agent 120, each mobile communication device 115 may comprise a user interface 132 that may be used by a user to avail data and/or voice communication services. The information and/or communications for such services may be transmitted across the telecommunications system 110 according to one or more protocols. The user negotiating agent 120 may be capable of communicating with the broker 105 to negotiate a price of a wireless service from a first operator, 125(1) within a service coverage area for a user.

The broker 105 comprises a service brokering agent 135 that negotiates cost or price of a service, such as a wireless service that may provide transport for data, voice, video or other services to a user. The service brokering agent 135 may enable the broker 105 to negotiate a price for a requested user service between a user and any one or more of the available operators, 125(1-M), such as network operators or service providers.

However, the resulting service price may depend on several parameters including, but not limited to, a type of service, a channel condition to the user (e.g., depredating on a position of the user), a current interference level and a current network load. These parameters may vary significantly depending upon on a specific location of the user within a service coverage area of the network 110 and a particular time of the day.

To this end, the service brokering agent 135 may provide a variation in price for the cost of a wireless service to the user by estimating a service cost based on the location of the user, the time of the day, and/or a current network traffic load. Thus, in one embodiment, the service brokering agent 135 may provide real-time location based price predictions to the mobile communication devices 115(1-N), enabling a user to significantly influence the price of the wireless service.

Consistent with an embodiment of the instant invention, a user may selectively connect to any one of the operators 125(1-M), i.e., connect to a first operator of choice as more than one operator may be available at each location because the communication networks of different operators 125(1-M) are generally overlapping. To negotiate service contracts between users and network operators/service providers, the service brokering agent 135 may provide location-dependent pricing statistics of competitors (such as WLAN operators and/or areas where the first operator does not offer coverage) to the operators 125(1-M), enabling a network operator or a service provider to optimize a communication network.

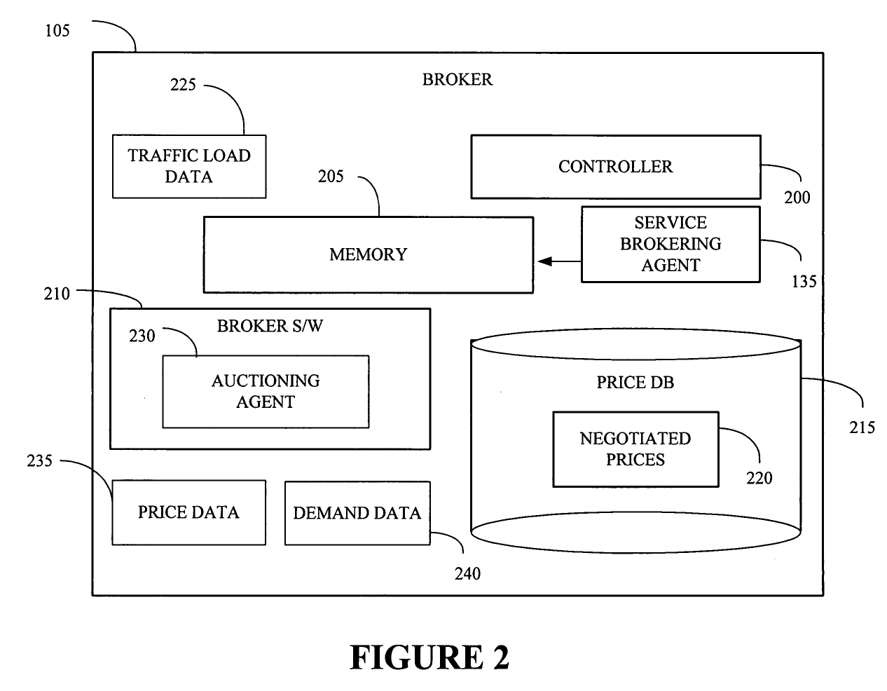

Turning now to FIG. 2, the broker 105 shown in FIG. 1 is illustrated to include the service brokering agent 135 in accordance with one illustrative embodiment of the present invention. The broker 105 may further comprise a controller 200 and a memory 205 storing instructions, such as the service brokering agent 135, a broker software (S/W) 210 and a price database 215 storing information on one or more negotiated prices 220 of a type of a wireless service based on a location of a user in the network 110 at a particular time. The broker S/W 210 may receive information on traffic load on the network 110 and store associated traffic load data 225.

In operation, the controller 200, in the illustrated embodiment, controls the flow of information between the mobile communication devices 115(1-N) and the operators 125(1-M). The broker S/W 210 may comprise instructions, such as a conventional auctioning agent 230. However, persons of ordinary skill in the art should appreciate that the present invention is not so limited. Moreover, instructions of the service broker agent 135 and the broker S/W 210 may be implemented in any desirable number of entities and may be stored in other desirable forms, such as firmware and/or hardware logic.

The broker 105 may generate a location and time based price database 215 which connects the negotiated prices 220 of the past service offerings with the estimated positions of the mobile communication devices 115(1-N) at the time of the service request. Based on this data, i.e., the estimated positions and the negotiated prices 220, the service brokering agent 135 may extrapolate the prices to one or more, such as all positions of interest to predict a price range for a given service at any location and time of the day.

According to one embodiment, the price range information may be illustrated to the user at the user interface 132 by colouring the background of a map of a mobile communication environment, i.e., a service coverage area as price regions, for example, a red colour may indicate a higher price region and a green colour may indicate a lower price region. The broker 105 may offer this service to a mobile communication device user, i.e., a user may be able to download an actual price map. In this way, using this price range information within the mobile communication environment, the user may actively influence the price of a requested service by choosing to move into price regions with a relatively better coverage, less network congestion and/or a relatively better channel conditions.

Likewise, the broker 105 may offer a similar service to the operators 125(1-M). By providing a location and time based pricing statistics and/or user demand statistics, the service brokering agent 135 may enable the operators 125(1-M) to optimize their networks, such as for maximum revenue by concentrating on a relatively more profitable regions that may be identified by the broker 105. More specifically, the service brokering agent 135 may enable the broker 105, as illustrated in FIG. 2, to use the price database 215 which stores for the negotiated services 220 pricing information including a service type, a time and a location of a mobile communication device 115 when requesting a service, such as the wireless service. The price database 215 may store the generated price maps based on the price data 235 and the generated demand maps based on the demand data 240. The service brokering agent 135 may enable the broker 105 to update the price database 215 with new information from one or more ongoing negotiations associated with a request for a wireless service.

The service brokering agent 135 may use the existing information on service prices, i.e., the negotiated prices 220 and locations of the mobile communication devices 115(1-N) to extrapolate the results for predicting the prices at other co-ordinates of the service coverage area. Using this extrapolation, the service brokering agent 135 may generate location and time dependent price maps based on the price data 235 which may be stored in the price database 215. The service brokering agent 135 may select and transmit a relevant part of a price data map, which covers the service coverage area of the user and includes price predictions for the current time, to the user. Likewise, the service brokering agent 135 may select and transmits a relevant data, e.g., the traffic load data 225, time dependent price maps based on the price data 235 and/or demand maps based on the demand data 240 to an operator 125 that requests this information as a service from the broker 105.

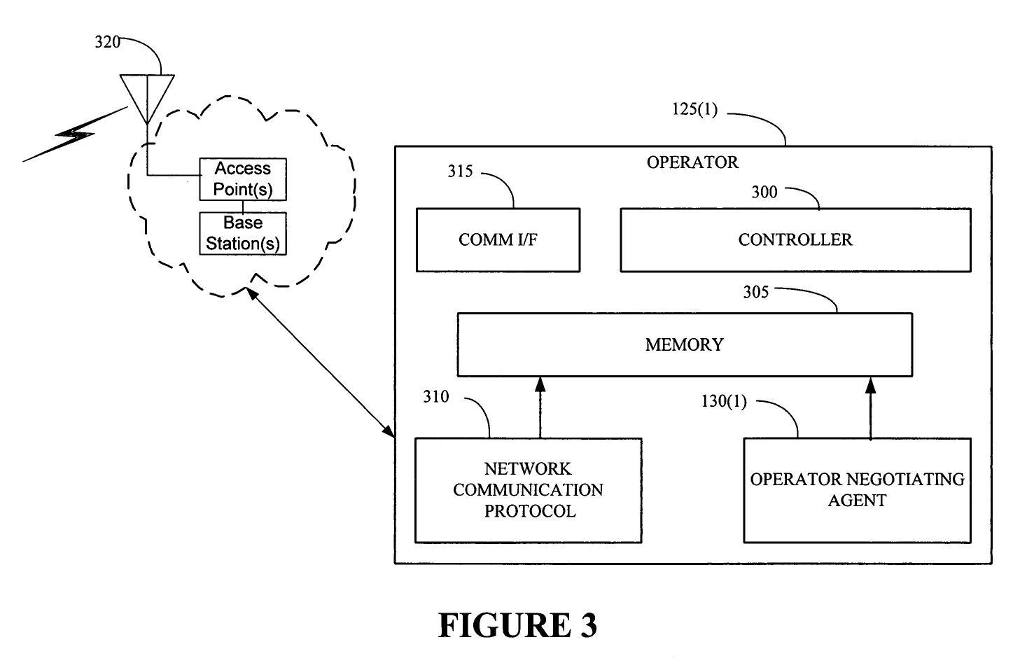

Referring to FIG. 3, the first operator 125(1) (e.g., an access point (AP) that plugs a plurality of wireless devices into a wired network) is shown to include the operator negotiating agent 130(1) shown in FIG. 1 for rendering a wireless service to the user in accordance with one illustrative embodiment of the present invention. The first operator 125(1) may comprise a controller 300, a memory 305 coupled to the controller 300 and storing instructions for exchanging wireless communications to and from the mobile communication device 115(1) based on one or more suitable protocols to negotiate a price of providing a service to a user over the network 110. To this end, in one embodiment, the memory 305 besides the operator negotiating agent 130(1) may store a conventional network communication protocol 310.

The first operator 125(1) may further comprise a communication interface (COMM I/F) 315 capable of sending downstream transmissions and receiving upstream transmissions over an antenna 320. For example, the COMM I/F 315 may include a receiver (RX) for upstream communication and a transmitter (TX) for downstream communication. The COMM I/F 315 may interface with a wireless local area network (LAN) that enables a user to roam around an area with the mobile communication device 115(1), e.g., a laptop (equipped with a wireless LAN card) and stay connected to the network 110 without being connected to a wire. The wireless LAN may enable exchange of data through an air interface using radio frequencies, as one example.

In one embodiment, the COMM I/F 315 may deploy an Institute of Electrical and Electronics Engineers (IEEE) 802.11 standard that refers to a family of specifications developed by the IEEE for wireless LAN technology. The IEEE standard called 802.11b or Wi-Fi specification published in 1997 is available from IEEE Operations Center, 445 Hoes Lane, Piscataway, N.J., 08854-1331, USA.

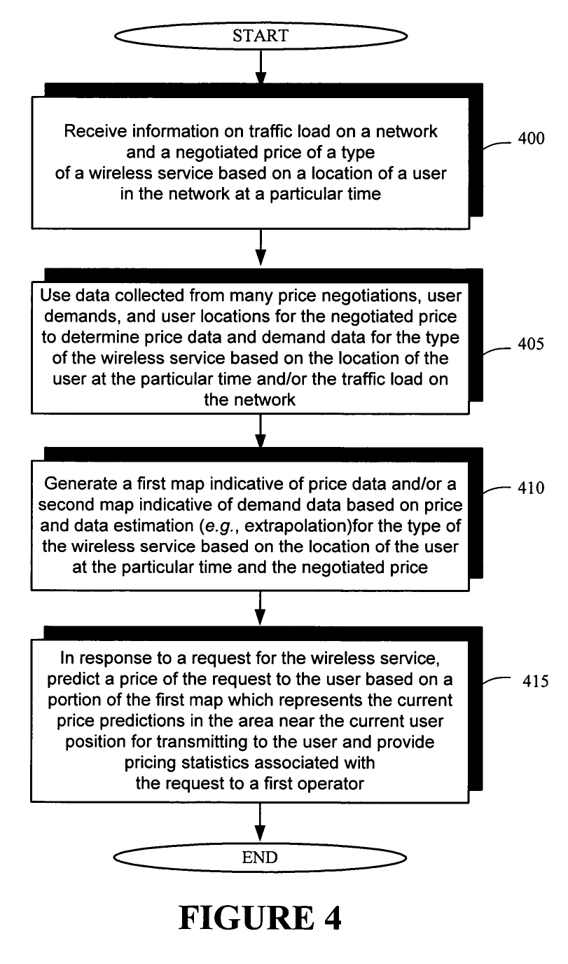

A stylized representation of a flow chart implementing a method is illustrated in FIG. 4 for estimating cost of rendering the wireless service to the user by the first operator 125(1) based on the price data 235 and the demand data 240 consistent with one embodiment of the present invention. At block 400, the broker 135 may receive information on the traffic load data 225 on the network 110 and information on the negotiated prices 220. The service brokering agent 135 may use data collected from one or more price negotiations, user demands, and user locations at a particular time for the negotiated prices 220 to determine price data 235 and demand data 240 for a type of the wireless service based on the location of the user at the particular time and/or the traffic load data 225 on the network 110, as shown at block 405.

In this manner, the broker 135 may predict a price of a request to the user and/or provide pricing statistics associated with the request to the first operator 125(1), such as a network operator or a service provider. The service brokering agent 135 may estimate cost of rendering the wireless service to the user by the first operator 125(1) based on the price data 235 and the demand data 240.

As shown in block 410, the service brokering agent 135 may generate at least one of a first map indicative of the price data 235 and a second map indicative of the demand data 240 based on price and data estimation (e.g., extrapolation) for the type of the wireless service based on the location of the user at the particular time and the negotiated price 220. In response to a request for the wireless service, the service brokering agent 135 may predict a price of the request to the user based on a portion of the first map indicative of the price data 235 which represents the current price predictions in the area near the current user position for transmitting to the user and provide pricing statistics associated with the request to the first operator 125(1), at block 415.

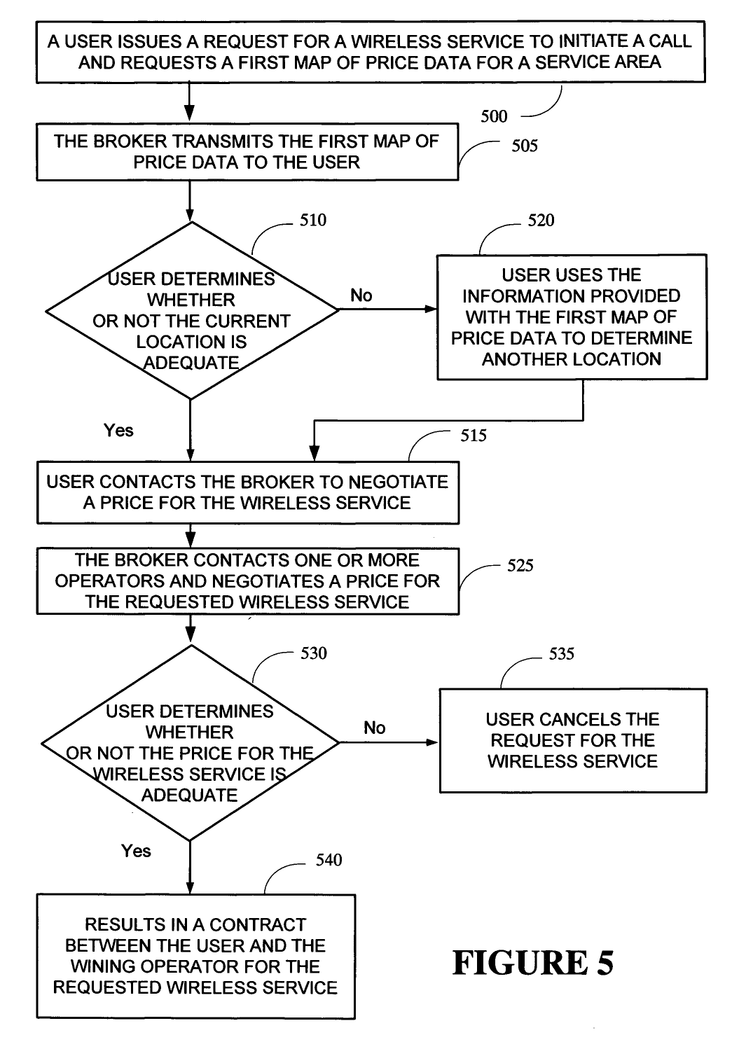

Finally, FIG. 5 illustrates a stylized representation of a flow chart implementing a method for handling a service request to broker a service contract between a user of the mobile communication device 115(1) and the first operator 125(1) based on the traffic load data 225 of the network 110, the price data 235 and/or demand data 240 consistent with one embodiment of the present invention. At block 500, a user, i.e., using the user I/F 132(1) of the mobile communication device 115(1) may issue a request for a wireless service to initiate a call. Specifically, the user negotiating agent 120(1) may request a first map of the price data 235 from the service brokering agent 135 for a desired service area that the network 110 serves for the telecommunication system 100 shown in FIG. 1. In response to the request, the broker 105 may transmit a current price map, e.g., the first map of the price data 235 to the user of the mobile communication device 115(1), as indicated at block 505.

At a decision block 510, the user negotiating agent 120(1) may determine whether or not the current location of the user is adequate to avail the requested wireless service rendered by the first operator 125(1). Essentially, the first map of the price data 235 may be used by the user (not only the user negotiating agent 120(1) to decide whether to request a call from the current position or if it makes sense to move to a cheaper position. If the location of the user is determined to be adequate, the user negotiating agent 120(1) may contact the service brokering agent 135 to negotiate a price for the requested wireless service, as shown at block 515. Conversely, when at the decision block 510, the user negotiating agent 120(1) ascertains that a better location may be adequate, the mobile communication device 115(1) may use the information provided with the first map of the price data 235 to locate another location, as set forth in block 520. For such purposes, the mobile communication device 115(1) proceeds to block 515.

At block 525, the service brokering agent 135 may contact the operator negotiating agents 130(1-M) of the one or more operators 125(1-M) to negotiate a price for the requested wireless service. At a decision block 530, the user negotiating agent 120(1) may determine whether or not the current price of the requested wireless service to the user is adequate to avail the requested wireless service rendered by an operator 125. If the price of the requested wireless service to the user is determined to be inadequate, the user negotiating agent 120(1) may cancel the request for the wireless service, as shown at block 535. Instead, when at the decision block 530, the user negotiating agent 120(1) finds that a negotiated price of the requested wireless service may be adequate, a service contract between the user negotiating agent 120(1) of the mobile communication device 115(1) and the winning operator, i.e., the operator negotiating agent 130(1) of the first operator 125(1) may result for the requested wireless service, as shown in block 540.

In some embodiments, by generating and providing location based pricing statistics and predictions, the broker 105 may provide a service to both, the users and network operators or service providers, resulting in substantial price savings and additional revenue, respectively. The broker 105 may allow a user to influence the price for a requested service by causing the user to select a location with a relatively good channel conditions and a high network capacity. A new location may result in significantly lower costs for the user when obtaining the requested service. That is, as a result of the availability of the pricing information, a user may avoid locations with relatively poor channel conditions, optimizing the network 110 use for the operators 125(1-M) due to a change of such user behaviour. For example, shop or restaurant owners may use such availability of the pricing information to generate visible “green zones” of relatively cheap wireless access zones by subsidising wireless access, or by installing UMTS and/or WLAN hotspots to make their premises more attractive for customers to spend time and shop.

Likewise, network operators and/or service providers may use the price and demand maps to optimize revenue streams by placing one or more base stations in relatively more profitable regions of a service coverage area. The price and demand maps may be used for optimization of a wireless network by improving the coverage in formerly “expensive” areas with relatively poor channel conditions and reception, since such areas may be readily identified as a revenue opportunity. In a similar fashion, the pricing and demand statistics may provide information on location based network capabilities of a set of competing operators and access technologies. For example, the operators 125(1-M) may use real-time location based pricing and demand statistics to identify a peak-demand and re-locate or re-configure the base-stations for a maximized profit. For such re-configuration, in one embodiment, a multi-sector base-station, for example, may dynamically re-configure the sectors to effectively cope with a higher demand. For such re-location, in another embodiment, mobile base stations may be deployed.

Portions of the present invention and corresponding detailed description are presented above in terms of software, or algorithms and symbolic representations of operations on data bits within a storage device or a semiconductor memory associated with a computing device, such as a computer or controller. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computing system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method comprising:
receiving information on traffic load on a network and a negotiated price of a type of a wireless service based on a location of a user in said network;
using information on said negotiated price to determine price data and demand data for said type of said wireless service based on at least one of said location of said user and said traffic load on said network; and
estimating cost of providing said wireless service to said user by a first operator based on said price data and said demand data.

2. A method, as set forth in claim 1, further comprising:
generating at least one of a first map indicative of price data and a second map indicative of demand data for said type of said wireless service based on said location of said user at a particular time and said negotiated price; and
in response to a request for said wireless service, predicting a price of said request to said user based on said at least one of said first and second map and providing pricing statistics associated with said request to said first operator.

3. A method, as set forth in claim 2, further comprising:
negotiating price of said request between said user and said first operator for a mobile communication device.

4. A method, as set forth in claim 3, further comprising:
collecting pricing information of said request based on said location of said user from a second operator capable of competing for said request.

5. A method, as set forth in claim 4, further comprising:
brokering a service contract between said user and said first operator based on said pricing information in real-time.

6. A method, as set forth in claim 4, further comprising:
processing said pricing information to generate said at least one of said first map indicative of price data and second map indicative of demand data in a mobile communication environment based on said location of said user at said particular time.

7. A method, as set forth in claim 6, further comprising:
providing at least one of a first statistics indicative of pricing and a second statistics indicative of user demand to at least one said first and second operators corresponding to said at least one of said first map indicative of price data and second map indicative of demand data.

8. A method, as set forth in claim 2, further comprising:
estimating positions of one or more mobile communication devices at the time of said request within a service coverage area for said type of said wireless service.

9. A method, as set forth in claim 8, further comprising:
generating a database of negotiated prices of said type of said wireless service based on a location and time of said one or more mobile communication devices.

10. A method, as set forth in claim 9, further comprising:
extrapolating prices to one or more positions of interest within said service coverage area to predict a price range for said type of said wireless service at a desired position and time based on said positions of one or more mobile communication devices and said database of negotiated prices of said type of said wireless service.

11. A mobile communication device associated with a network, said mobile communication device comprising:
an agent capable of communicating with a broker to negotiate a price of a wireless service from a first operator within a service coverage area for a user, wherein said broker is adapted to:
receive information on traffic load on said network and a negotiated price of a type of said wireless service based on a location of said user in said network,
use information on said negotiated price to determine price data and demand data for said type of said wireless service based on at least one of said location of said user and said traffic load on said network, and
estimate cost of providing said wireless service to said user by said first operator based on said price data and demand data.

12. A mobile communication device, as set forth in claim 11, wherein a price of said wireless service is based on said type of said wireless service, a channel condition to said user, an interference level and said traffic load on said network.

13. A mobile communication device, as set forth in claim 11, wherein said broker to:
generate a first map indicative of price data and a second map indicative of demand data for said type of said wireless service based on said location of said user at a particular time and said negotiated price to cause said agent to influence a price for a request for said wireless service by moving said mobile communication device from a first area to a second area within said service coverage area with said second area having a relatively better coverage, less network congestion or better channel conditions than said first area; and
broker a service contract in real-time between said user and said first operator based on pricing information of said request based on said location of said user from a second operator capable of competing for said request to provide a location based price prediction service to said user.

14. A mobile communication device, as set forth in claim 11, wherein said mobile communication device being defined at least in part by a Universal Mobile Telecommunication System (UMTS) protocol.

15. An operator associated with a network to provide a wireless service to a mobile communication device, said operator comprising:
an agent capable of communicating with a broker to negotiate a price of said wireless service for a user within a service coverage area, wherein said broker is adapted to:
receive information on traffic load on said network and a negotiated price of a type of said wireless service based on a location of said user in said network,
use information on said negotiated price to determine price data and demand data for said type of said wireless service based on at least one of said location of said user and said traffic load on said network, and
estimate cost of providing said wireless service to said user by said operator based on said price data and demand data.

16. An operator, as set forth in claim 15, wherein said broker is adapted to:
provide pricing statistics associated with a request for said wireless service, said pricing statistics include at least one of a first statistics indicative of pricing and a second statistics indicative of user demand corresponding to at least one of a first map indicative of price data and a second map indicative of demand data; and
broker a service contract in real-time between said user and said operator based on pricing information of said request based on said location of said user at a particular time from a second operator capable of competing for said request to optimize said network for a desired profit.

17. An operator, as set forth in claim 15, wherein said operator being defined at least in part by a Universal Mobile Telecommunication System (UMTS) protocol.

18. A telecommunication system comprising:
a broker including a controller that negotiates a price of a request within a service coverage area from a user for a wireless service between a first operator coupled to one or more mobile communication devices over a network; and
a memory coupled to said controller, said memory storing instructions to:
receive information on traffic load on said network and a negotiated price of a type of said wireless service based on a location of said user in said network,
use information on said negotiated price to determine price data and demand data for said type of said wireless service based on at least one of said location of said user and said traffic load on said network, and
estimate cost of providing said wireless service to said user by said first operator based on said price data and demand data.

19. A telecommunication system, as set forth in claim 16, wherein said one or more mobile communication devices and said first operator being defined at least in part by a Universal Mobile Telecommunication System (UMTS) protocol.

20. An apparatus for exchanging data with a mobile communication device and an operator over a network to negotiate a service contract between a user and a service provider, the apparatus comprising:
means for receiving information on traffic load on said network and a negotiated price of a type of a wireless service based on a location of said user in said network;
means for using information on said negotiated price to determine price data and demand data for said type of said wireless service based on at least one of said location of said user and said traffic load on said network; and
means for estimating cost of providing said wireless service to said user by said operator based on said price data and demand data.

21. An article comprising a computer readable storage medium storing instructions that, when executed cause a system to:
receive information on traffic load on a network and a negotiated price of a type of a wireless service based on a location of a user in said network;
use information on said negotiated price to determine price data and demand data for said type of said wireless service based on at least one of said location of said user and said traffic load on said network; and
estimate cost of providing said wireless service to said user by a first operator based on said price data and demand data.

22. An article, as set forth in claim 21, comprising a medium storing instructions that, when executed cause a system to:
generate at least one of a first map indicative of price data and a second map indicative of demand data for said type of said wireless service based on said location of said user at a particular time and said negotiated price; and
in response to a request for said wireless service, predict a price of said request to said user based on said at least one of said first and second map and provide pricing statistics associated with said request to said first operator.

23. An article, as set forth in claim 22, comprising a medium storing instructions that, when executed cause a system to:
negotiate price of said request between said user and said first operator for a mobile communication device.

24. An article, as set forth in claim 23, comprising a medium storing instructions that, when executed cause a system to:
collect pricing information of said request based on said location of said user from a second operator capable of competing for said request; and
broker a service contract between said user and said first operator based on said pricing information in real-time.

25. An article, as set forth in claim 24, comprising a medium storing instructions that, when executed cause a system to:
process said pricing information to generate said at least one of said first map indicative of price data and second map indicative of demand data in a mobile communication environment based on said location of said user at said particular time; and
provide at least one of a first statistics indicative of pricing and a second statistics indicative of user demand to at least one said first and second operators corresponding to said at least one of said first map indicative of price data and second map indicative of demand data.
